(19) United States
(12) Patent Application Publication
(10) Pub. No.: US 2011/0119676 A1
(43) Pub. Date: May 19, 2011

(54) Resource File Localization

(75) Inventor: Jonathan B. Gallant, Issaquah, WA (US)

(73) Assignee: Microsoft Corporation, Redmond, WA (US)

(21) Appl. No.: 12/620,607

(22) Filed: Nov. 18, 2009

(51) Int. Cl. G06F 9/46

(52) U.S. Cl. 718/104

(57) ABSTRACT

A system and method for localizing an application resource file. An application localizer may receive an application resource file containing text strings to be localized. The application localizer extracts each text string and sends it to a remote automated translation service, receiving a corresponding localized text string. The localizer writes each of the localized text strings to generate a localized application resource file. Configuration specifications may specify target locales, a format of the application resource file, or a format of application resource file names.

### BACKGROUND

In some computer environments, the process of developing an application includes the creation of one or more corresponding resource files. A resource file contains data descriptive of graphical user interface (GUI) elements. For example, it may include text strings that are to be displayed in GUI labels, on buttons, titles, menus, or the like. A resource file may be compiled into a binary file and linked with an application prior to execution of the application or dynamically linked during program execution.

Localization of a computer application is the process of adapting a program for a specific locale, which may be one or more of a language, country, region, or group of users. This may include translating text strings, modifying punctuation, converting date formats, or other changes. The use of resource files facilitates localization. One or more resource files corresponding to an application can be sent to individual localizers who are fluent in the target language or knowledgeable of the target group of users. Each localizer translates the text strings from the source language to the target language or dialect. A resource file specific to each locale can be shipped with the application, allowing an end user to select the locale of their choice. The resource file corresponding to the selected locale is then used as a source of strings and other data when generating a GUI.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly, a system, method, and components operate to localize a computer application. In one embodiment, this may be performed by receiving a source application resource file associated with the computer application, receiving specifications of one or more target locales, extracting text strings from the source application resource file, sending each text string to a remote automated translation service, receiving localized strings from the remote translation service, and generating a localized application resource file containing the localized strings.

In one embodiment, the system receives a specification of a format of the source application resource file, and extracting the strings is based on the received format. The system may receive a file name format specification and generate the localized application resource file based on this specification.

The application resource file may have a structure of a .resx file, as specified for the .NET environment. The remote translation service may be a Web service. A Web service is a software service designed to support machine-to-machine interaction over a network such as the Internet. It has an application programming interface (API) that may be accessed over the network. It may include a dictionary of trademarks or product names to facilitate localizing each text string.

To the accomplishment of the foregoing and related ends, certain illustrative aspects of the system are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

To assist in understanding the present invention, reference will be made to the following Detailed Description, which is to be read in association with the accompanying drawings, wherein:

FIG. 1 is a block diagram illustrating an example embodiment of a localization system that may be employed to localize a computer application;

FIG. 2 is a flow diagram illustrating an example embodiment of a process for localizing a computer application; and

FIG. 3 is a block diagram of a computing device that may implement embodiments of the technologies described herein.

### DETAILED DESCRIPTION

Example embodiments of the present invention now will be described more fully hereinafter with reference to the accompanying drawings, which form a part hereof, and which show, by way of illustration, specific example embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to a previous embodiment, though it may. Furthermore, the phrase “in another embodiment” as used herein does not necessarily refer to a different embodiment, although it may. Thus, various embodiments of the invention may be readily combined, without departing from the scope or spirit of the invention. Similarly, the phrase “in one implementation” as used herein does not necessarily refer to the same implementation, though it may, and techniques of various implementations may be combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The components described herein may execute from various computer-readable media having various data structures thereon. The components may communicate via local or remote processes such as in accordance with a signal having one or more data packets (e.g. data from one component interacting with another component in a local system, distributed system, or across a network such as the Internet with other systems via the signal). Software components may be stored, for example, on computer-readable storage media including, but not limited to, an application specific integrated circuit (ASIC), compact disk (CD), digital versatile disk (DVD), random access memory (RAM), read only memory (ROM), floppy disk, hard disk, electrically erasable programmable read only memory (EEPROM), flash memory, or a memory stick in accordance with embodiments of the present invention.

The term computer-readable media as used herein includes both storage media and communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media.

As used herein, the term “application” refers to a computer program or a portion thereof, and may include associated data. An application may be an independent program, or it may be designed to provide one or more features to another application. An “add-in” and a “plug-in” are examples of applications that interact with and provides features to a “host” application.

An application is made up of any combination of application components, which may include program instructions, data, text, object code, images or other media, security certificates, scripts, or other software components that may be installed on a computing device to enable the device to perform desired functions. Application components may exist in the form of files, libraries, pages, binary blocks, or streams of data.

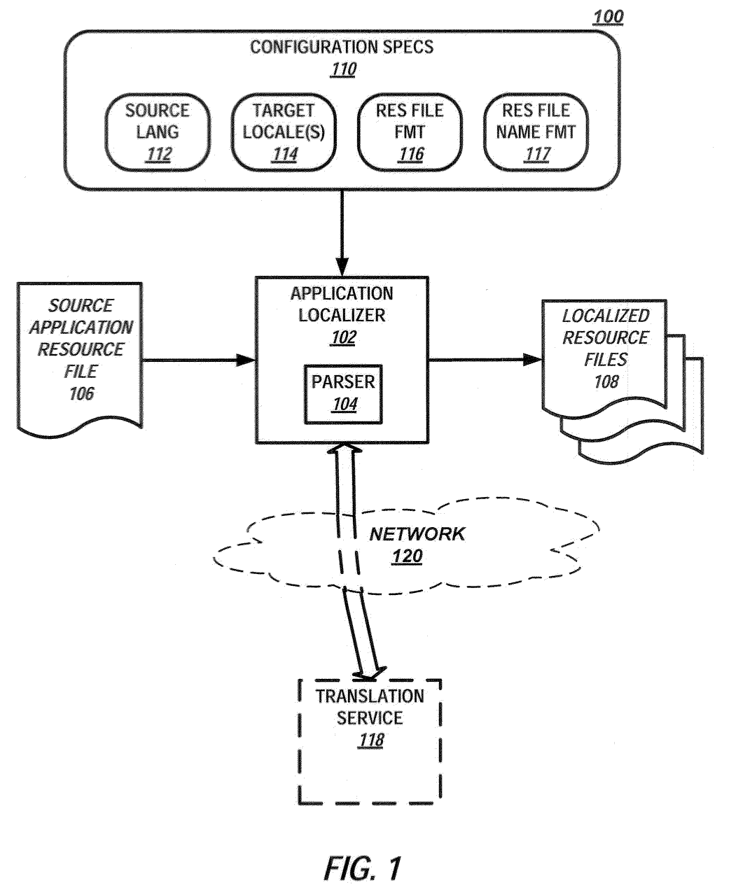

FIG. 1 is a block diagram illustrating an example embodiment of a localization system 100 that may be employed to lay out a GUI of an application. In various embodiments, localization system 100 may be implemented with one or more computing devices configured in a variety of ways.

As illustrated, localization system 100 includes application localizer 102. Application localizer 102 may be implemented as one or more computing devices, or as computer software executing on one or more computing devices. FIG. 4 illustrates one embodiment of a computing device that may be used to implement application localizer 102. Briefly, application localizer 102 may receive one or more source application resource files, automatically localize each such file, and generate corresponding target application resource files.

In one embodiment, application localizer 102 includes parser 104. Parser 104 may be used to parse the structure of a source application resource file and extract each text string to be localized. It may perform actions to facilitate the generation of target application resource files by inserting each localized string into a target buffer or file when generating target application resource files.

Example localization system 100 may receive one or more source application resource files 106, process the file as described herein, and generate one or more localized application resource files 108. In one embodiment, each source application resource file 106 results in one localized application resource file 108 for each target locale. However, in some implementations, a localized application resource file may be shared by multiple locales, a single application resource file may be divided to generate multiple corresponding localized application resource files for a target locale, or multiple source application resource files may be combined to generate fewer localized resource files. Thus, the correspondence between source application resource files and localized resource files may be, but is not necessarily, a multiple of the number of target locales.

In some implementations, application resource files 106 or localized resource files 108 may be implemented as a subset of a larger file, or as data in a database or registry. Reference to a resource file, as used herein, refers to the corresponding resource data and includes various implementations such as these, unless stated otherwise.

As illustrated, example localization system 100 may include configuration specifications 110. Configuration specifications 110 are received by application localizer 102 and provide specifications for use to perform localization. In one embodiment, configuration specifications 110 include source language specifications 112 and target locale specifications 114. These indicate the locale of the source application resource files and the localized resource files, respectively. Application localizer 102 may perform translations based on the source and target locales, as indicated by these configuration specifications. In one embodiment, a configured default source language may be used in place of a source language specification 112.

In one embodiment, configuration specifications 110 may include resource file format specifications 116, which provide a schema or description of the application resource file structure. Application localizer 102, or more particularly parser 104, may use the resource file format specifications 116 to parse each resource file and extract strings. This facilitates the use of localization system 100 for resource files of different structures. In one embodiment, source application resource file 106 employs the structure of a .resx resource file, as specified for the .NET environment provided by Microsoft Corporation, of Redmond, Wash., and resource file format specifications 116 provides a specification of this structure. In one embodiment, the specifications of resource file format specifications 116 are configured within application localizer 102. In some embodiments, resource file format specifications may include program instructions configured to facilitate parsing of an application resource file. The instructions may in the form of a plug-in, library, script, or other computer program component.

Resource file format specifications 116 may provide specifications to distinguish text that is to be translated from text that is not to be translated. The latter may include variable names or other names that are programmatically used. For example, a resource file may include the following segment:

<data name=“FaqQuestion6” xml:space=“preserve”>
<value>What are the recommended screen resolutions?</value>
</data>

In the above segment, the text string “What are the recommended screen resolutions?” may be displayed to a user and is to be localized. The strings “FaqQuestion6′ and “preserve” are not to be modified. Thus, a parser may use the specification file format to identify and extract the localizable strings.

In some configurations, text strings within the application resource file may be used to generate speech instead of, or in addition to, display of the strings. As used herein, the term “presented to” a user refers to a visual display or an audio presentation to the user.

The following is an example of a localized resource file segment, in which the above segment has been localized with a target locale of France:

<data name=“FaqQuestion6” xml:space=“preserve”>
<value>Quels sont les résolutions d'écran recommandée?</value>
</data>

In one embodiment, configuration specifications 110 may include resource file name format specifications 117. This specification indicates a format of a file name, database field, or key value corresponding to a resource file. Application localizer 102 may use the resource file name format specifications 117 to generate localized resource files 108. More specifically, the resource file name format specifications 117 may be used to generate file, field, or key names, or to associate a resource file with an existing file, field, or key. An example of a resource file name format specification 117 is

<string>.{0}.resx

where “{0}” is a placeholder for a name of a locale. Using this resource file name format specification, a source resource file having the name “profile.en-US.resx” may be localized to generate resource files having the following names:
profile.fr.resx
profile.en-GB.resx
profile.zh-cn.resx
profile.zh-tw.resx

Corresponding to the locales of French, Great Britain-English, China-Chinese, and Taiwan-Chinese, respectively.

Configuration specifications 110, and the components contained therein, may be implemented in the form of one or more files or portions thereof. They may be implemented as data passed in a function call, message, or by another mechanism. They may be specified by a user in a user interface, such as selections in a graphical user interface. Thus, the use of configuration specifications is not limited to any specific implementation.

In the illustration of FIG. 1, example localization system 100 communicates with, and employs automated translation service 118 to translate each string. Translation service 118 is illustrated in dashed lines to indicate that it is not necessarily a part of localization system 100, but may be a service employed by the system. Translation service 118 may be a remotely located automated Web service with an API for translating one or more blocks of text. Translation service 118 employs machine translation technology to translate each block of text. This may include, for example, one or more dictionaries and heuristics representing knowledge of a language. Localizer 102 may send each extracted text string, along with a specification of a source locale and a target locale, to translation service 118 and receive a corresponding translated string.

In one embodiment, translation service 118 is an automated service that receives a text string, a specification of a source locale, and a specification of a target locale. The translation service 118 performs a translation of the text string to a localized text string of the target locale. In one embodiment, translation service 118 employs a dictionary of trademarks, product names, or service names. It may use the dictionary to properly translate or refrain from translating these names in order to maintain their desired meaning, even when embedded in a longer string or when words within a name have a meaning other than as a name in the target locale.

In one embodiment, localizer 102 may communicate with translation service 118 via network 120. Network 120 may include a local area network, a wide area network, a cellular network, or a combination thereof. In one embodiment, network 120 includes the Internet, which is a network of networks. Network 120 may include wired communication mechanisms, wireless communication mechanisms, or a combination thereof. Communications between localizer 102 and translation service 118 may employ one or more of various wired or wireless communication protocols, such as IP, TCP/IP, UDP, HTTP, SSL, TLS, FTP, SMTP, WAP, Wi-Fi, WiMax, Bluetooth, WLAN, spread spectrum, or digital modulation.

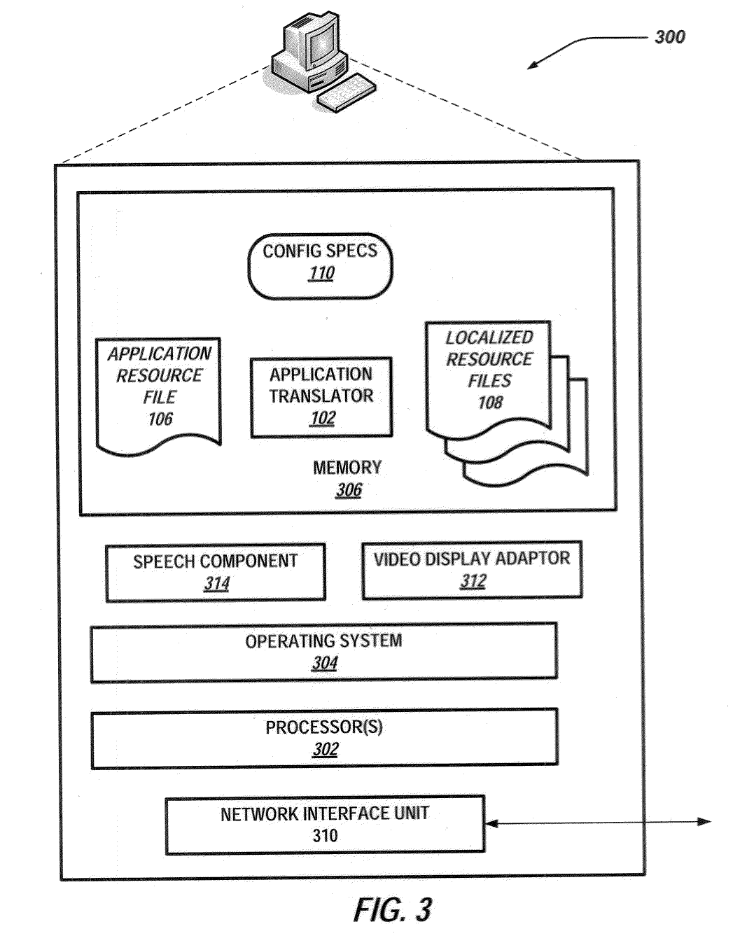

FIG. 1 is only an example of a suitable system and is not intended to suggest any limitation as to the scope of use or functionality of the present invention. Thus, a variety of system configurations may be employed without departing from the scope or spirit of the present invention. For example, any of the functions of localizer 102 may be combined into one or more computing devices, distributed, or replicated among multiple computing devices in a variety of ways. FIG. 3 illustrates an example of a computing device that may be used to implement localizer 102.

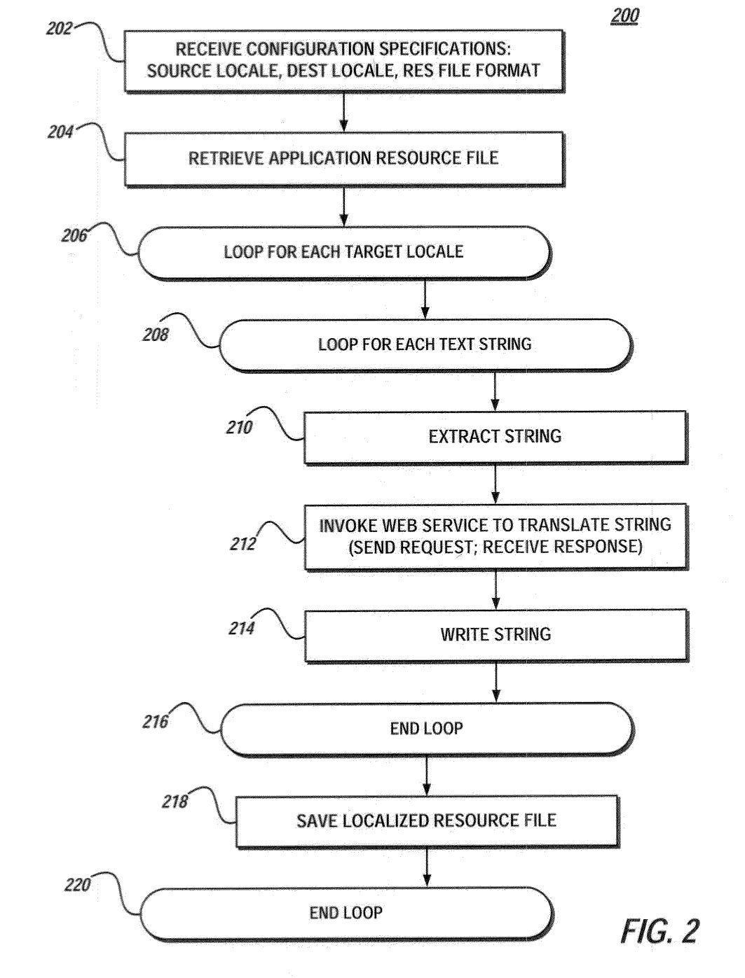

FIG. 2 is a flow diagram illustrating an example embodiment of a process 200 for localizing an application resource file. In one embodiment, the actions of process 200, or a portion thereof, are performed by application localizer 102 of FIG. 1.

The illustrated portions of process 200 may be initiated, after a start block, at block 202, where configuration specifications may be received. As discussed herein, configuration specifications may include one or more of a source locale, destination locale, or a resource file format. Though not illustrated, in some implementations, configuration specifications may include a location of the source resource file(s) or the localized resource file(s). This may be, for example, a folder, file name, or Uniform Resource Identifier (URI).

Process 200 may flow to block 204, where a specified source application resource file may be retrieved. Though FIG. 2 illustrates a process for localizing one resource file, the process may iterate over any number of resource files. The process may flow to loop 206, where a loop of actions is performed. In one implementation, loop 206 iterates for each specified target locale.

In the embodiment illustrated by FIG. 2, loop 206 includes loop 208. In one implementation, loop 208 may iterate for each text string contained within the source resource file. In one implementation, loop 208 includes the actions of blocks 210-214.

At block 210, a text string is extracted from a resource file. Though the illustrated implementation shows one string is extracted and translated during each iteration of loop 208, in various implementations, more than one string may be extracted and translated during each iteration. The process may flow to block 212, where a web translator service is invoked to translate the extracted string. The Web translator service may be, for example, translation service 118 of FIG. 1. In one embodiment, invocation of a Web translator service may include exchanging messages across network 120 to the Web translator service, in which one or more messages that include the extracted string are sent to the Web translator service and one or more messages that include a corresponding localized string are received in response. The outgoing message(s) may further include a specification of the source locale and the destination locale. Invocation may include additional messages for establishing or maintaining a communication, based on the protocol in use. It may include various messages to locate a Web translator service.

It is to be noted that in some processes, the localization of at least some strings may result in a “translated” string that is identical to the source string. For example, a translation from U.S. English to British English may have many such strings. Further, some company names, product names, or other proper names may be identical in different locales. In some embodiments, a source text string may be modified, or data may be included to identify names that are not to be translated. For example, a name may be capitalized to indicate that it is not to be translated. A translated string may be modified to reverse these changes.

The process may flow to block 214, where a translated string is written, for example to a buffer for subsequent inclusion in a localized file. In some implementations, the actions of block 214 may include writing the translated string to a database, registry, or other structure.

The process may flow to block 216, where loop 208 is terminated. The process may flow to block 218, where a localized resource file containing the localized strings received within the current iteration of loop 206 may be saved. In some implementations, some of the actions of block 218 may be performed incrementally within loop 208.

The process may flow to block 220, where loop 206 is terminated. As discussed, loop 206 may iterate for teach target locale. In one embodiment, the system may compile each localized resource file to generate a corresponding binary resource file. The binary resource files may be linked or otherwise combined with an application program. Upon exiting from loop 206, process 200 may exit or return to a calling program.

In one embodiment, a single Web service may be employed to localize text strings for multiple target locales. Identification of the target locale may be included with each request to localize a text string, or in another manner. In one embodiment, multiple Web services may be employed, each one having an associated set of target locales.

FIG. 3 shows one embodiment of a computing device 300, illustrating selected components of a computing device that may be used to perform functions described herein and attributed to application localizer 102. Computing device 300 may include many more components than those shown, or may include less than all of those illustrated.

As illustrated, computing device 300 includes one or more processors 302, which perform actions to execute instructions of various computer programs. In one configuration, each processor 302 may include one or more central processing units, one or more processor cores, one or more ASICs, cache memory, or other hardware processing components and related program logic. As illustrated, computing device 300 includes an operating system 304. Operating system 304 may be a general purpose or special purpose operating system. The Windows® family of operating systems, by Microsoft Corporation, of Redmond, Wash., are examples of operating systems that may execute on computing device 300.

Memory 306 may include one or more of a variety of types of computer storage media, including volatile or non-volatile memory, RAM, ROM, solid-state memory, disk drives, optical storage, or any other medium that can be used to store digital information. In one configuration, memory 306 may store application translator 102 and configuration specifications 110. In some configurations, any one or more of these components, or a portion thereof, may be implemented in hardware, software, or a combination thereof. Memory 306 may store application resource file 106 or localized resource files 108.

Computing device 300 may include a video display adapter 312 that facilitates display of localized text strings to a user, or speech component 314 that converts text to audio speech and presents the spoken strings to a user. Though not illustrated in FIG. 3, computing device 300 may include a basic input/output system (BIOS), and associated components. Computing device 300 may also include a network interface unit 310 for communicating with a network, such as network 120 of FIG. 1, or remote devices such as those that may implement translation service 118. Embodiments of computing device 300 may include one or more of a display, keyboard, pointing device, audio component, microphone, voice recognition component, or other input/output mechanisms.

It will be understood that each block of the flowchart illustration of FIG. 2, and combinations of blocks in the flowchart illustration, can be implemented by software instructions. These program instructions may be provided to a processor to produce a machine, such that the instructions, which execute on the processor, create means for implementing the actions specified in the flowchart block or blocks. The software instructions may be executed by a processor to provide steps for implementing the actions specified in the flowchart block or blocks. In addition, one or more blocks or combinations of blocks in the flowchart illustrations may also be performed concurrently with other blocks or combinations of blocks, or even in a different sequence than illustrated without departing from the scope or spirit of the invention.

The above specification, examples, and data provide a complete description of the manufacture and use of the composition of the invention. Since many embodiments of the invention can be made without departing from the spirit and scope of the invention, the invention resides in the claims hereinafter appended

What is claimed as new and desired to be protected by Letters Patent of the United States is:

1. A computer-based method of localizing a computer application, comprising:
a) receiving a source application resource file associated with the computer application, the application resource file containing a plurality of text strings for presentation by the computer application;
b) receiving specifications of one or more target locales;
c) extracting, from the source application resource file, the plurality of text strings based on a format of the source application resource file;
d) sending each of the plurality of text strings to a remote automated translation service;
e) receiving, from the remote translation service, a plurality of localized strings corresponding to the plurality of text strings; and
f) generating a localized application resource file containing the localized strings.

2. The computer-based method of claim 1, further comprising:
a) receiving a specification of the format of the source application resource file; and
b) receiving a file name format specification;
wherein generating the localized application resource file is based on the file name format specification.

3. The computer-based method of claim 1, sending each text string to a remote automated translation service comprises sending the text string and a specification of at least one target locale to a Web service.

4. The computer-based method of claim 1, wherein the remote translation service is a Web service.

5. The computer-based method of claim 1, wherein the application resource file employs the structure of a .resx file, as specified for the .NET environment.

6. The computer-based method of claim 1, the remote translation service comprising a dictionary of trademarks or product names to facilitate localizing each text string.

7. The computer-based method of claim 1, further comprising receiving a file name format specification, generating the localized application resource file based on the file name format specification, and wherein the remote translation service is a Web service.

8. The computer-based method of claim 1, further comprising compiling the localized application resource file to generate a binary resource file.

9. A computer-based system for localizing a computer application, the system comprising:
a) a parser that identifies text strings in a source application resource file associated with the computer application, the application resource file containing a plurality of text strings for presentation by the computer application;
b) an application localizer configured to perform actions including:
i) receiving the source application resource file;
ii) receiving specifications of one or more target locales;
iii) employing the parser to extract, from the source application resource file, the plurality of text strings; and
iv) for each of the plurality of text strings, sending the text string to a remote automated translation service, receiving a localized text string from the remote automated translation service, and inserting the localized text string into a target localized application resource file.

10. The computer-based system of claim 9, the actions further comprising compiling the localized application resource file to generate a binary resource file.

11. The computer-based system of claim 9, the parser configured to receive a specification of the source application resource file format and employ the source application resource file format to identify each of the plurality of text strings.

12. The computer-based system of claim 9, the parser configured to parse a .resx file as specified for the .NET environment and identify each of the plurality of text strings.

13. The computer-based system of claim 9, the actions further comprising employing the parser to generate the target localized application resource file by inserting each localized text string into the target application resource file.

14. The computer-based system of claim 9, the actions further comprising receiving a file name format specification and generating the target localized application resource file based on the file name format specification.

15. The computer-based system of claim 9, the one or more target locales comprising a first target locale and a second target locale, further comprising employing the remote automated translation service to localize each text string to the first target locale and the second target locale.

16. A computer-readable storage medium comprising computer program instructions for automatically localizing a computer application having an associated application resource file, the program instructions executable by a processor to perform actions including:
a) receiving a source application resource file associated with the computer application, the application resource file containing a plurality of text strings for presentation by the computer application;
b) receiving specifications of one or more target locales;
c) parsing the source application resource file to extract each of the plurality of text strings based on a format of the source application resource file;
d) sending each of the plurality of text strings to an automated Web translation service;
e) receiving, from the Web translation service, a plurality of localized strings corresponding to the plurality of text strings; and
f) generating a localized application resource file containing the localized strings.

17. The computer-readable storage medium of claim 16, the source application resource file is a .resx file as specified for the .NET environment.

18. The computer-readable storage medium of claim 16, the actions further comprising:
a) receiving a specification of the format of the source application resource file; and
b) receiving a file name format specification;
c) generating the localized application resource file based on the file name format specification.

19. The computer-readable storage medium of claim 16, the actions further comprising compiling the localized application resource file to generate a binary resource file.

20. The computer-readable storage medium of claim 16, sending each text string to the Web translation service comprises sending a specification of at least one target locale.
